(19) United States
(12) Patent Application Publication
(10) Pub. No.: US 2005/0249900 A1
(43) Pub. Date: Nov. 10, 2005

(54) Injection molded parts and method of making same

(75) Inventors: Vincent Henri Barre, Seabrook, TX (US); Jeff Nairn, League City, TX (US); Michael Allen McLeod, Seabrook, TX (US); Layne Lumas, Dickinson, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 10/838,513

(22) Filed: May 4, 2004

(51) Int. Cl. B32B 27/32; B32B 7/04

(52) U.S. Cl. 428/35.7; 428/523; 428/339; 264/259; 264/279; 264/279.1; 264/537

(57) ABSTRACT

Disclosed is a method for preparing an injection molded article comprising bringing an injection molded substrate into contact with a polymer film during an injection molding process at a point in the injection molding process, the resulting part having improved surface properties such as low heat seal initiation temperature while retaining substantially all of the mechanical characteristics of the substrate. Random polypropylene copolymers are disclosed as being useful for preparing the polymer films.

### BACKGROUND OF THE INVENTION

1. Field of the Invention

The present invention relates to molded polymer articles and methods of making same. The present invention particularly relates to injection molded polymer articles and methods of making same.

2. Background of the Art

Preparing injection molded parts using polymers is well known within the art of preparing articles using polymers. For example, U.S. Pat. No. 4,165,875 to Robert H Dykehouse discloses preparing a bowling pin by injection molding a high impact polypropylene belly and, thereafter, inserting into the belly a wood laminate core. An even older example is U.S. Pat. No. 3,581,630 to Del Piano, et al. Therein, it is disclosed to prepare a plastic ski track composed of interlocking track elements roughly rectangular in shape. The elements may be fabricated by injection molding of a plastic composition, such as polyethylene-based compound.

A more recent application of the art of injection molding can be found in U.S. Pat. No. 6,568,082 to Pouettre, et al. This reference teaches that a razor can be prepared with the razor head having an anti-friction element firmly secured to the razor head. The anti-friction element is formed of a sole and an upper layer. The upper layer is secured to the sole such as by bonding, molding, coextrusion, overmolding, or twin-shot injection molding. The sole then is secured to the razor head by welding.

Overmolding is described on the internet at:

http://www.estane.com/process/molding/OvermoldingProcess.asp as having two major categories: insert molding and multi-shot molding. The insert molding process is described as involving one or more of the sub-components being placed in a mold by hand or automatically and a molten polymer is then injected into the same cavity forming the component. Multi-shot molding requires the use of multiple injection units, each independently injecting the desired plastic material into a more complex mold design forming the multi-component assembly. In this publication it is also stated that one of the most critical factors necessary to obtain a successful overmolded part is the bond between the sub-components. It is disclosed that this is either achieved via chemical adhesion between compatible plastics or mechanical interference/interlocking means. Insert molding allows the use of a chemical adhesive to be applied to the inserted sub-components prior to molding, if required for enhanced adhesion.

One problem with injection molding polymers is that the resultant article may not have all of the properties that would be desirable due to the material used to prepare the article. For example, polymers that are useful for preparing a container because they have good dimensional stability or impact resistance may not have good surface properties. The process for overmolding is complex and requires the use of adhesives, or subsequent steps, to weld, position in the mold, or otherwise attach subcomponents. Steps taken to resolve these problems or add properties to the surface of an injection molded article can be undesirably expensive.

### SUMMARY OF THE INVENTION

In one aspect, the present invention is an injection molded article including an injection molded substrate and adherent thereto a polymer film or insert. The polymer film or insert is attached to the substrate by bringing the substrate into contact with the polymer film during an injection molding process at a point in the injection molding process when the temperature of either the substrate or the polymer film or both the substrate and the polymer film is sufficient to form a bond between the substrate and the polymer film or insert. The film or insert has a surface that can form a heat seal with the substrate that is superior to a heat seal that can be formed with other polymers and the substrate.

In another aspect, the present invention is a method for preparing an injection molded article, the method including bringing an injection molded substrate into contact with a polymer film or insert during an injection molding process at a point in the injection molding process when the temperature of either the substrate or the polymer film or insert or both the substrate and the polymer film or insert is sufficient to form a thermally-induced bond between the substrate and the polymer film. The film or insert has a surface that can form a heat seal with other polymers that is superior to a heat seal that can be formed with other polymers and the substrate.

In still another aspect, the present invention is an injection molded article including an injection molded substrate and adherent thereto a polymer film or insert. The polymer film or insert is attached to the substrate by bringing the substrate into contact with the polymer film or insert during an injection molding process at a point in the injection molding process when the temperature of either the substrate or the polymer film or insert or both the substrate and the polymer film or insert is sufficient to form a heat seal between the substrate and the polymer film or insert. The polymer film or insert is prepared using a metallocene random polypropylene copolymer and the injection molded substrate is prepared using a polypropylene homopolymer or copolymer. The film or insert has a surface that can form a heat seal with other polymers that is superior to a heat seal that can be formed with other polymers and the substrate. Also, the molded part has physical properties essentially similar to that of the substrate.

### BRIEF DESCRIPTION OF THE DRAWINGS

For a detailed understanding and better appreciation of the present invention, reference should be made to the following detailed description of the invention and the embodiments, taken in conjunction with the accompanying drawings, wherein:

FIG. 1 is a photograph of an injection molded part of the present invention;

FIG. 2 is a photograph of an injection molded plaque of the present invention including a label;

FIG. 3 is a graph of the maximum seal force as a function of temperature for an example of the present invention and a comparative example; and

FIG. 4 is a photograph of a blow molded bottle of the present invention.

### DETAILED DESCRIPTION OF INVENTION

In one embodiment, the present invention is an injection molded article including an injection molded substrate and, adherent thereto, a polymer film or insert. For the purposes of the present invention, the term polymer film also includes inserts, particularly thin inserts. The process of injection molding is used to form plastic substrates into plastic articles such as the bowling pins and ski tracks described above. In injection molding, plastic is fed into an injection molding machine in the form of small granules or pellets. The plastic enters a barrel where a screw moves the plastic forward and applies shear and heat to the plastic. The screw turns on each backstroke, pushing molten plastic in front of it. A mold of the article to be made is connected to the machine and, during an injection cycle, the mold closes and the screw pushes forward during the injection stroke, forcing liquid plastic through a nozzle into the mold cavity. The mold stays closed while the plastic cools and hardens, a time which can range from seconds to minutes depending upon what plastic material is being used and the shape and size of the object being molded. The plastic enters the mold in a molten state, but the mold is usually a large block of metal with water cooling. At the end of the injection cycle, the mold opens and the molded object is removed, sometimes by a robotic take-out arm or other device to automate the process.

In addition to the injection molding process described above, there are also other, more complicated processes that can be used with the method of the present invention. For example, two shot molding is one of many two-component processes available today. Unlike other multi material molding processes, the co-injection process is characterized by its ability to completely encapsulate an inner core resin with an outer skin material. This encapsulation of one resin by another provides product in which only one material is evident, unless you section the product. A cross section of a molding shows a three-layer effect: skin, core, and skin. Co-injection process mechanics rely on the sequential injection of two different materials through the same gate(s), and usually with some amount of simultaneous injection. In general, a majority of skin material is injected into a cavity, followed by a combination of both skin and core materials flowing into the same cavity, and then followed by the balance of the core material to fill the cavity. Restated, the injection sequence is: skin, followed by skin and core concurrently, followed by core. In another embodiment, the skin layer if injected first, then the core layer followed by a small amount of skin to purge the injection nozzle and seal the par at the injection gate.

Overmolding, as already described, can also be used with the method of the present invention. The continuous extrusion blow molding variation of injection molding, such as is used to prepare milk jugs and soda bottles, is also within the scope of the present invention. Common variations of injection molding are included within the meaning of the term injection molding for purposes of the present invention. Other examples of such variations include co-injection molding; shear controlled orientation in injection molding which is described at:
http://www.plasticstechnology.com/articles/199903fa2.html) and sometimes referred to as SCORIM; Microcellular Foam and MuCell-based injection molding, which is described at:
   http://www.trexel.com/magazine/may02.pdf; injection-compression molding, which is described at:
http://www.ikt.uni-stuttgart.de/institut/mitarbeiter/stoll/fillflow pps.pdf; and fluid-assist injection molding, which is described at:
   http://www.immunet.com/articles?article=2212,

In the method of the present invention, there is an injection molded substrate and, adherent thereto, a polymer film. The injection molded substrate is prepared using a polymer selected so that adhesion occurs with the film under injection molding temperature and pressure conditions. Of course, the polymer used to prepare the substrate is also selected to have the physical properties necessary to meet the specifications of the items being molded. For example, if the object being molded is a milk jug, the polymer used to prepare the milk jug must have the dimensional stability, impact resistance, cold temperature fracture resistance, etc., to be useful for preparing a milk jug.

Similarly, the polymer film of the method of the present invention is selected to be thermally bonded to the injection molded substrate under injection molding temperature and pressure conditions. Thermally bonding, or heat sealing, is a process wherein two materials are brought together at a temperature wherein one or both of the materials become tacky and adhere one to another is and the bond is generally strengthened when the temperature of the two materials is lowered. The polymer film is also selected to impart some desirable property to surface of the injection molded substrate. For example, it may be necessary to further attach a label to the injection molded substrate and it may be desirable to use heat sealing to do so. A polymer film could be selected that would facilitate such a subsequent heat sealing. For example, the present invention can be used with Film laminates such as the FLUOREX® Exterior film laminates that are described at: http://www.paintfilm.com/pdf/techhowto.pdf

The pairing of the polymers used to prepare the injection molded substrate and the polymer film of the present invention can be done by taking into consideration the compatibility of the two polymers. For example, a polypropylene is more likely to be compatible with another polypropylene than a very different polymer such as, for example, a polystyrene. It is therefore an embodiment of the method of the present invention to use similar, or compatible, polymers types to prepare both the injection molded substrate and the polymer film of the present invention.

The polymers used to prepare the polymer films and inserts of the present invention are selected so that they will impart a desirable property to the injection molded object, namely providing a surface that can make a good heat seal. A good heat seal means that the material has a low heat seal initiation temperature as determined using ASTM F88. Or stated another way, the polymer films and inserts of the present invention have a lower heat seal initiation temperature than the substrates upon which they are bound.

In one embodiment of the present invention, the polymers used to prepare the polymer films and inserts of the present invention are selected from the group consisting of metallocene polypropylene homopolymers, metallocene random polypropylene copolymers, Zeigler-Natta polypropylene homopolymers, Zeigler-Natta random polypropylene copolymers, and mixtures thereof. In another embodiment, the polymers used to prepare the polymer films of the present invention are selected from the group consisting of metallocene polypropylene homopolymers, metallocene random polypropylene copolymers, and mixtures thereof. In still another embodiment, the polymers used to prepare the polymer films of the present invention are metallocene random polypropylene copolymers.

The polypropylene polymers and random polypropylene copolymers useful with the method of the present invention are those prepared with metallocene catalysts. The copolymers useful with the present invention have an ethylene content of from about 0.01 to about 8 percent. In one embodiment, the copolymers useful with the present invention have an ethylene content of from about 1 to about 6 percent. In another embodiment, the copolymers useful with the present invention have an ethylene content of from about 2 to about 4.5 percent. In still another embodiment of the present invention the polymers are syndiotactic polypropylene homopolymers and random copolymers. These polymers and methods of making them are well known in the art and have been disclosed in references such as U.S. Pat. No. 6,579,962 to Wheat, et al., which is incorporated herein by reference. Specific metallocene polymers that can be used with the present invention include, but are not limited to: EOD 02-14 and EOD 02-16J and FINAPLAS series, all available from ATOFINA.

The polymers useful for preparing the injection molded substrates of the present invention include any that can be bonded with a polymer film during an overmolding operation. Included in this group are polypropylene, polyethylene, polypropylene copolymers, polyethylene copolymers, polystyrene, polyamide, polyvinylidene fluoride, polymethyl methacrylate, polycarbonate polymers, mixtures thereof or any thermoplastic or mixture of thermoplastics that can be injection or blow molded. Others such polymers include cyclic olefin copolymers as disclosed in:
http://www.plasticstechnology.com/articles/200211fa2.html; thermoplastic elastomers as disclosed in:
http://www.plasticstechnology.com/articles/200210cu5.html; and ionomers and oxypolyproylene as disclosed in:
http://www.plaspec.com/articles/200311cu1.html.
   Alloys of these materials can also be used with the method of the present invention.

The polymer films useful with the method of the present invention can, in one embodiment, have at least some level of adhesion to a mold used for injection molding. The polymer films useful with the method of the present invention can also have at least some amount of elasticity. In one embodiment of the present invention, the polymer films of the present invention are placed into contact with the mold of an injection molding machine and adhere to the surface of the mold without the need for an adhesive. As the injection molded substrate is formed on top of the polymer film, the polymer film may stretch to replicate the shape of the mold and bond with the injection molded substrate substantially with limited deformation of the final part.

The polymer inserts useful with the present invention can be prepared prior to the injection molding process or concurrent with it. In one embodiment of the present invention, a complex injection molded article is prepared by concurrently: forming a polymer insert by extruding the polymer insert into a mold, placing a label onto a portion of the surface of the polymer insert, and injection molding a substrate onto the polymer insert and label. The polymer insert is heat sealed or thermally bonded to the injection molded substrate while the label is held in place by the polymer insert. By concurrently, it is meant that all of these actions take place within a single cycle of the injection molding machine. The resultant injection molded article has a label held in place by the polymer insert. In a conventional process, this could have required one or even two additional production steps and represents an advance in the art of preparing injection molded articles.

While, in one embodiment, the polymer films useful with the method of the present invention can be used with an adhesive or adhesive device, in another embodiment, an external force is used to hold the polymer film in place during the injection molding cycle. Exemplary forces include, but are not limited to tape, ion guns, and just the act of allowing the mold to cut the film as it closes when an uncut film is used.

One advantage of many of the embodiments of the present invention is that the injection molded substrate is many times thicker than the polymer film and so the physical properties of the injection molded articles are essentially unchanged. This is very different from a conventional process where, for example, a film covering a label is welded using microwaves. The polymer films of the present invention are, in most embodiments, no thicker than necessary to achieve the desired surface affect. In one embodiment, the polymer films of the present invention have a thickness of from about 0.5 mil (12.7 micrometres) to 20 mil (508 micrometres). In another embodiment, the polymer films of the present invention have a thickness of from about 1 mil (25.4 micrometres) to 10 mil (254 micrometres). In still another embodiment, the polymer films of the present invention have a thickness of from about 2 mil (50.8 micrometres) to 5 mil (127 micrometres).

The method of the present invention can be used to prepare many types of injection molded articles. For example, the present invention can be used to prepare parts such as containers having protecting films; containers having labels held in place with a polymer film that has been heat sealed in place, and even used to prepare lids on containers that have tamper-prevention films. One embodiment of the present invention is a tamper resistant film on a medicine bottle cap or box while another embodiment is a tamper proof seal on a compact disc, optical disc or DVD.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

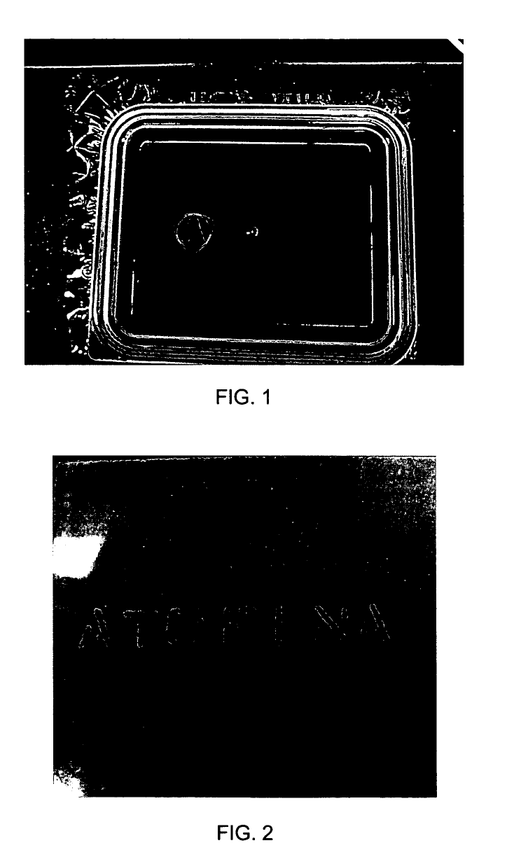

A plaque having a polymer film heat sealed to one side is prepared by preparing a 2 mil (50.8 micrometres) film using a syndiotactic polypropylene random copolymer having a melting point of 130° C. and a melt flow rate of 4.1 g/10 minutes commercially available from ATOFINA under the trade designation FINAPLAS 1471. The film is cut to fit a food container mold and a 50 mil (1270 micrometres) plaque cavity. The film is set onto the mold at the opposite from the injection port. The cavities are then filled using injection molding with a random copolymer polypropylene having a melt flow rate of 30 g/10 minutes sold under the trade designation 7823 MZ by ATOFINA. The resultant food lid is displayed in the photo designated FIG. 1. Note that the film covers the inside of the sealing lip of the food container lid. The plaque is tested for certain physical properties and the results are displayed below in Table 1.

### Example 2

Example 1 is repeated substantially identically except that a label is printed on the inside of the polymer film, protected by the film on one side and the substrate on the other side. The resulting plaque is displayed in the photo designated FIG. 2.

### Example 3

Example 1 is repeated substantially identically except that the film is prepared having a thickness of 20 mil (508 micrometres). The plaque is tested for certain physical properties and the results are displayed below in Table 1.

### Comparative Example I

A plaque is prepared as in Example 1 except that no film is used. The plaque is tested for certain physical properties and the results are displayed below in Table 1.

### Example 4

Example 1 is repeated substantially identically except that the polymer film used is EOD 02-15j, a metallocene random polypropylene copolymer and the mold is filled with 7622MZ, both available from ATOFINA. The resulting plaque is tested for heat seal properties when heat sealed with EOD 02-16j and is displayed below in Table 2. The trace of the heat seal test is displayed in the graph found in FIG. 3.

### Comparative Example II

Example 4 is repeated substantially identically except that no film is used. The resulting plaque is tested for heat seal properties when heat sealed with EOD 02-16j and is displayed below in Table 2. The trace of the heat seal test is displayed in the graph found in FIG. 3.

### Example 5

Example 1 is repeated substantially identically except that the polymer film used is EOD 02-14j, a metallocene random polypropylene copolymer and the mold is filled with 7622MZ, both available from ATOFINA. The resulting plaque is tested for heat seal properties when heat sealed with EOD 02-16j and is displayed below in Table 2.

### Comparative Example III

Example 4 is repeated substantially identically except that no film is used. The resulting plaque is tested for heat seal properties when heat sealed with EOD 02-14j and is displayed below in Table 2.

### Example 6

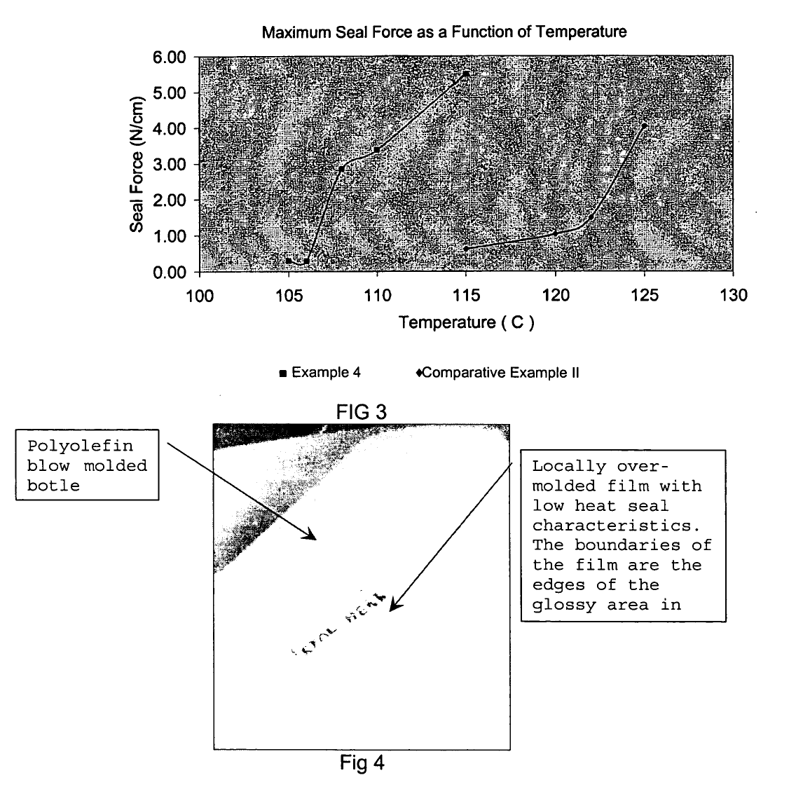

A blow molded polyolefin bottle having a strip film thermally bonded during over molding process on the exterior of the bottle is prepared by extruding a 2 mil (50.8 micrometres) film of EOD 02-15j, a metallocene random copolymer with a heat seal temperature (die pressure 413 kPa, dwell time 1.0 s) of 105° C. The film is cut in a vertical strip and placed inside the bottle mold. A parison of 5502 polyethylene material with a melt flow index of 0.35 (190° C./2.16 kg) is extruded and blown in the mold. The resultant container is displayed in the photo designated FIG. 4.

TABLE 1

| | | | COMPARATIVE |
|---|---|---|---|
| | EXAMPLE 1 | EXAMPLE 3 | EXAMPLE 1 |
| Instrumental Imapct | | | |
| +72 F.¹ | | | |
| Energy to Max | 15.26 | 12.86 | 15.17 |
| Load, FT-LB | | | |
| Energy to Max | 20.7 | 17.4 | 20.6 |
| Load, Newton- | | | |
| meters | | | |
| Energy After Max | 11.82 | 7.47 | 10.28 |
| Load, FT-LB | | | |
| Energy After Max | 16.0 | 10.1 | 13.9 |
| Load, Newton- | | | |
| meters | | | |
| Total Energy, | 27.08 | 20.33 | 25.45 |
| FT-LB | | | |
| Total Energy, | 36.7 | 27.6 | 34.5 |
| Newton-meters | | | |
| Instrumental Impact | | | |
| +20 F.¹ | | | |
| Energy to Max | 1.01 | 1.41 | 1.22 |
| Load, FT-LB | | | |
| Energy to Max | 1.4 | 1.9 | 1.7 |
| Load, Newton- | | | |
| meters | | | |
| Energy After Max | 0.64 | 0.34 | 0.38 |
| Load, FT-LB | | | |
| Energy After Max | 0.9 | 0.5 | 0.5 |
| Load, Newton- | | | |
| meters | | | |
| Total Energy, | 1.65 | 1.75 | 1.6 |
| FT-LB | | | |
| Total Energy, | 2.2 | 2.4 | 2.2 |
| Newton-meters | | | |
| Optical & Hardness | | | |
| Gloss 45°² | 59.1 | 51 | 56.7 |
| Hardness Rockwell³ | 80 | 78 | 79 |
| Haze Percent⁴ | 11.7 | — | 10.3 |

¹ASTM-D882
²ASTM-D2457
³ASTM-D785-03
⁴ASTM-D1003

TABLE 2

| Heat Seal | | Comparative | | Comparative |
|---|---|---|---|---|
| properties | Example 4 | Example II | Example 5 | Example III |
| Avg. Force | 107.3 | 122.5 | 121 | 130.2 |
| Seal Initiation | | | | |
| Temperature @ | | | | |
| 1.83 N/cm | | | | |

ASTM-F88

1. An injection molded article comprising an injection molded substrate and adherent thereto a polymer film or insert wherein the polymer film or insert is attached to the substrate by bringing the substrate into contact with the polymer film or insert during an injection molding process at a point in the injection molding process when the temperature of either the substrate or the polymer film or insert or both the substrate and the polymer film or insert is sufficient to form a bond between the substrate and the polymer film or insert, and the film or insert has a surface that can form a heat seal with the substrate that is superior to a heat seal that can be formed with other polymers and the substrate.

2. The injection molded article of claim 1 wherein polymer film or insert is prepared using a polymer selected from the group consisting of metallocene polypropylene homopolymers, metallocene random polypropylene copolymers, Ziegler-Natta polypropylene homopolymers, Ziegler-Natta random polypropylene copolymers, and mixtures thereof.

3. The injection molded article of claim 2 wherein the polymer film is prepared using a metallocene random polypropylene copolymer.

4. The injection molded article of claim 3 wherein the metallocene random polypropylene copolymer has an ethylene content of from about 0.01 to about 8 weight percent.

5. The injection molded article of claim 4 wherein the metallocene random polypropylene copolymer has an ethylene content of from about 1 to about 6 weight percent.

6. The injection molded article of claim 5 wherein the metallocene random polypropylene copolymer has an ethylene content of from about 2 to about 4.5 weight percent.

7. The injection molded article of claim 2 wherein the polymer film is prepared using a Zeigler-Natta random polypropylene copolymer.

8. The injection molded article of claim 7 wherein the Zeigler-Natta random polypropylene copolymer has an ethylene content of from about 0.01 to about 8 weight percent.

9. The injection molded article of claim 8 wherein the Zeigler-Natta random polypropylene copolymer has an ethylene content of from about 3 to about 8 weight percent.

10. The injection molded article of claim 9 wherein the Zeigler-Natta random polypropylene copolymer has an ethylene content of from about 4 to about 7 weight percent.

11. The injection molded article of claim 1 wherein the injection molded substrate is prepared using a polymer selected from the group consisting of polypropylene, polyethylene, polypropylene copolymers, polyethylene copolymers, polystyrene, polyamide, polyvinylidene fluoride, polymethyl methacrylate, polycarbonate polymers, and mixtures thereof.

12. The injection molded article of claim 1 wherein the injection molded substrate is prepared using a polymer alloy including at least two polymers selected from the group consisting of polypropylene, polyethylene, polypropylene copolymers, polyethylene copolymers, polystyrene, polyamide, polyvinylidene fluoride, polymethyl methacrylate, polycarbonate polymers and mixtures thereof.

13. The injection molded article of claim 1 additionally comprising a label between the polymer film or insert and the injection molded substrate.

14. The injection molded article of claim 1 wherein the injection molded article is a container with a label held in place by a polymer film or insert bonded to the injection molded substrate.

15. The injection molded article of claim 1 wherein the injection molded article is a container cap or box having a tamper resistant seal.

16. The injection molded article of claim 1 wherein the injection molded article is a tamper proof seal on a CD, optical disc, or DVD.

17. The injection molded article of claim 1 wherein the polymer film has a thickness of from about 0.5 mil (12.7 micrometres) to 20 mil (508 micrometres).

18. The injection molded article of claim 17 wherein the polymer film has a thickness of from about 1 mil (25.4 micrometres) to 10 mil (254 micrometres).

19. The injection molded article of claim 18 wherein the polymer film has a thickness of from about 2 mil (50.8 micrometres) to 5 mil (127 micrometres).

20. A method for preparing an injection molded article comprising bringing an injection molded substrate into contact with a polymer film or insert during an injection molding process at a point in the injection molding process when the temperature of either the substrate or the polymer film or insert or both the substrate and the polymer film or insert is sufficient to form a heat seal between the substrate and the polymer film or insert wherein the film or insert has a surface that can form a heat seal with other polymers that is superior to a heat seal that can be formed with other polymers and the substrate.

21. The method of claim 20 wherein the injection molding process is an overmolding injection molding process.

22. The method of claim 20 wherein the injection molding process is a continuous extrusion blow molding process.

23. The method of claim 20 wherein the injection molding process additionally comprises an automated process for placing the polymer film into a mold.
